(19) United States
(12) Patent Application Publication
(10) Pub. No.: US 2012/0008053 A1
(43) Pub. Date: Jan. 12, 2012

(54) METHOD AND SYSTEM FOR FAST CHANNEL CHANGE BETWEEN PROGRAMS UTILIZING A SINGLE DECODER TO CONCURRENTLY DECODE MULTIPLE PROGRAMS

(76) Inventors: Jeffrey Fisher, Dublin, CA (US); Shivapirakasan Kanakaraj, Bangalore (IN); Sandeep Bhatia, Bangalore (IN); Subramanian Kuppuswamy, Bangalore (IN); Andrew Robinson, Cardiff (GB)

(21) Appl. No.: 12/857,173

(22) Filed: Aug. 16, 2010

Related U.S. Application Data
(60) Provisional application No. 61/363,529, filed on Jul. 12, 2010.

(51) Int. Cl. H04N 5/50

(52) U.S. Cl. 348/731; 348/E05.097

(57) ABSTRACT

A video receiver comprising a single decoder may be operable to decode concurrently, by the single decoder, a plurality of received programs. The plurality of received programs may comprise a current program associated with a current channel and one or more other programs associated with one or more corresponding other channels. The video receiver may be operable to cause display of the decoded current program associated with the current channel for viewing. The plurality of received programs may be received via a single transport stream. The plurality of received programs may be received via a plurality of transport streams. The video receiver may be operable to switch from the current channel to one of the other channels based on a received request. The video receiver may be operable to cause display of one of the decoded other programs which is associated with the switched channel.

### CROSS-REFERENCE TO RELATED APPLICATIONS/INCORPORATION BY REFERENCE

This patent application makes reference to, claims priority to, and claims benefit from U.S. Provisional Application Ser. No. 61/363,529, which was filed on Jul. 12, 2010.

The above stated application is hereby incorporated herein by reference in its entirety.

### FIELD OF THE INVENTION

Certain embodiments of the invention relate to communication systems. More specifically, certain embodiments of the invention relate to a method and system for fast channel change between programs utilizing a single decoder to concurrently decode multiple programs.

### BACKGROUND OF THE INVENTION

Digital video capabilities may be incorporated into a wide range of devices such as, for example, digital televisions, digital direct broadcast systems, digital recording devices, and the like. Digital video devices may provide significant improvements over conventional analog video systems in processing and transmitting video sequences with increased bandwidth efficiency.

Various video encoding standards, for example, MPEG-1, MPEG-2, MPEG-4, H.263, advanced video coding (AVC), and VC-1, have been established for encoding digital video sequences in a compressed manner. Broadcast digital cable, terrestrial and satellite networks may distribute audio, video and/or data via multiplexed bitstreams. For example, a bitstream may be a transport stream (TS) which may comprise one or more elementary streams (ES). Packets in the same elementary stream all have the same packet identifier (PID). A bitstream, such as a transport stream (TS), may carry a plurality of digital video/audio programs or channels.

In various digital video systems, there may be a latency time between when a user makes a request for a new program or channel and when the digital video system presents the requested new program or channel to the user. For example, a user may enter a channel up/down request for changing a program or channel. Due to complexities in acquiring digital signals, changing programs or channels may take much longer than changing programs or channels in legacy analog distribution environments.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for fast channel change between programs utilizing a single decoder to concurrently decode multiple programs, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary video communication system that is operable to provide fast channel change between programs utilizing a single decoder to concurrently decode multiple programs, in accordance with an embodiment of the invention.

FIG. 2 is a block diagram illustrating an exemplary video receiver that is operable to provide fast channel change between programs utilizing a single decoder to concurrently decode multiple programs, in accordance with an embodiment of the invention.

FIG. 3 is a block diagram illustrating an exemplary transport stream comprising a plurality of programs, in accordance with an embodiment of the invention.

FIG. 4 is a block diagram illustrating exemplary multiple transport streams each comprising a plurality of programs, in accordance with an embodiment of the invention.

FIG. 5 is a flow chart illustrating exemplary steps for fast channel change between programs utilizing a single decoder to concurrently decode multiple programs, in accordance with an embodiment of the invention.

### DETAILED DESCRIPTION OF THE INVENTION

Certain embodiments of the invention can be found in a method and system for fast channel change between programs utilizing a single decoder to concurrently decode multiple programs. In various embodiments of the invention, a video receiver comprising a single decoder may be operable to concurrently decode, by the single decoder, a plurality of received programs, where the plurality of received programs may comprise a current program associated with a current channel and one or more other programs associated with one or more corresponding other channels. The video receiver may be operable to cause display of the decoded current program associated with the current channel for viewing. In an embodiment of the invention, the plurality of received programs may be received by the video receiver via a single transport stream. In another embodiment of the invention, the plurality of received programs may be received by the video receiver via a plurality of transport streams.

The video receiver may be operable to receive a request from, for example a user or remote control device, to switch channel from the current channel to one of the other channels. In this regard, the video receiver may be operable to switch from the current channel to one of the other channels based on the received request from the user. The video receiver may be operable to cause display of one of the decoded other programs which may be associated with the switched channel.

In an exemplary embodiment of the invention, the one or more corresponding other channels may comprise one or more up channels with respect to the current channel and/or one or more down channels with respect to the current channel. In instances when channels are being changed upwards with respect to the current channel, the one or more corresponding other channels may comprise one or more up channels with respect to the current channel. In instances when channels are being changed downwards with respect to the current channel, the one or more corresponding other channels may comprise one or more down channels with respect to the current channel. One of the other channels may comprise a last channel which was previously selected for display, for example.

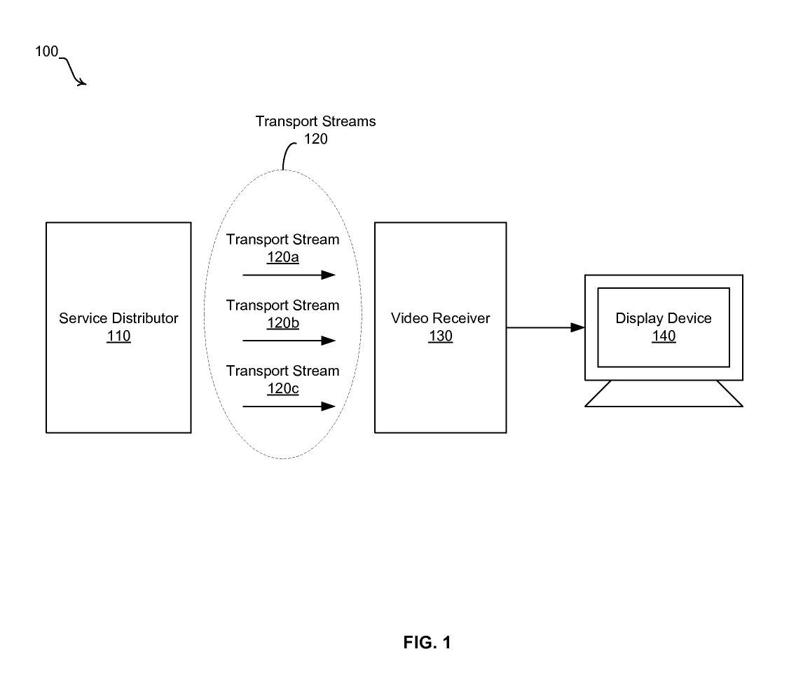

FIG. 1 is a block diagram illustrating an exemplary video communication system that is operable to provide fast channel change between programs utilizing a single decoder to concurrently decode multiple programs, in accordance with an embodiment of the invention. Referring to FIG. 1, there is shown a video communication system 100. The video communication system 100 may comprise a service distributor 110, a plurality of transport streams 120 of which transport streams 120a-120c are illustrated, a video receiver 130 and a display device 140.

The service distributor 110 may comprise suitable logic, circuitry, interfaces and/or code that may be operable to distribute content or programs via one or more of the transport streams 120 to the video receiver 130. The service distributor 110 such as, for example, a headend system may be operable to provide various services such as, for example, distribution, multicast, and/or quality of service necessary for a reliable and timely transmission of content or programs to the video receiver 130. The service distributor 110 may utilize, for example, a cable TV network, a satellite broadcasting network, the Internet protocol (IP) data network such as the Internet, and/or a wireless communication network for delivery of services or content to the video receiver 130.

The video receiver 130 may comprise suitable logic, circuitry, interfaces and/or code that may be operable to receive content or programs via one or more of the transport streams 120 from the service distributor 110. In an exemplary embodiment of the invention, the video receiver 130 such as, for example, a set-top box (STB), a cable TV receiver, a satellite TV receiver or a digital TV (DTV) may be operable to decode concurrently, utilizing a single decoder, a plurality of received programs. The plurality of received programs may comprise a current program associated with a current channel and one or more other programs associated with one or more corresponding other channels. The video receiver 130 may be operable to cause the display device 140 to display the decoded current program associated with the current channel for viewing. The video receiver 130 may be operable to switch from the current channel to one of the other channels and may cause the display device 140 to display one of the decoded other programs which may be associated with the switched channel.

The display device 140 may comprise suitable logic, circuitry, interfaces and/or code that may be operable to display or present decoded content or programs, which may be received from the video receiver 130, to viewers for viewing.

In operation, a video receiver 130 may be operable to decode concurrently, utilizing a single decoder, a plurality of programs which may be received from the service provider 110. The plurality of received programs may comprise a current program associated with a current channel and one or more other programs associated with one or more corresponding other channels. The video receiver 130 may be operable to cause the display device 140 to display the decoded current program associated with the current channel for viewing. In an embodiment of the invention, the plurality of received programs may be received by the video receiver 130 via a single transport stream such as the transport stream 120a. In another embodiment of the invention, the plurality of received programs may be received by the video receiver 130 via a plurality of transport streams such as the transport streams 120a-120c.

The video receiver 130 may be operable to receive a request from, for example a user or a remote control device, to switch channel from the current channel to one of the other channels. In this regard, the video receiver 130 may be operable to switch from the current channel to one of the other channels, based on the received request, and cause the display device 140 to display one of the decoded other programs which may be associated with the switched channel. In this regard, since the program associated with the switched channel has already been decoded by the video receiver 130 before a channel change, time delays associated with steps in the channel change sequence may be avoided or reduced. For example, the time delays which may be avoided or reduced may comprise the time delays associated with RF tuning, digital signal demodulation, program specific information (PSI) acquisition, entitlement control message (ECM) acquisition, video sequence data acquisition and/or presentation time stamp (PTS) management.

In an exemplary embodiment of the invention, the one or more corresponding other channels may comprise one or more up channels of the current channel and/or one or more down channels of the current channel. For example, the current channel which is being watched may be channel 7 and a user or viewer is not in the middle of changing channels or has paused channel changes. In this instance, the video receiver 130 may be operable to concurrently decode one or more up channels such as channel 8 and/or 9 and one or more down channels such as channel 6 and/or 5, for example.

In instances when channels are being changed upwards with respect to the current channel, the one or more corresponding other channels may comprise one or more up channels with respect to the current channel. For example, a user or viewer may be changing channels upwards from channel 7. In this instance, for example, the video receiver 130 may be operable to concurrently decode channel 7, channel 8 and channel 9. The video receiver 130 may also be operable to concurrently decode non-consecutive up channels such as, for example, channel 7, channel 9 and channel 12.

In instances when channels are being changed downwards with respect to the current channel, the one or more corresponding other channels may comprise one or more down channels with respect to the current channel. For example, a user or viewer may be changing channels downwards from channel 7. In this instance, for example, the video receiver 130 may be operable to decode concurrently channel 7, channel 6 and channel 5. The video receiver 130 may also be operable to concurrently decode non-consecutive down channels such as, for example, channel 7, channel 5 and channel 2.

In an exemplary embodiment of the invention, one of the other channels may comprise a last channel which was previously selected for display. For example, a user or viewer who might have previously watched channel 13 has changed channel from channel 13 to current channel 7. While decoding the current channel 7 for current viewing, the video receiver 130 may be operable to also decode channel 13, which is the last channel, so as to allow fast channel change to and/or from the last channel.

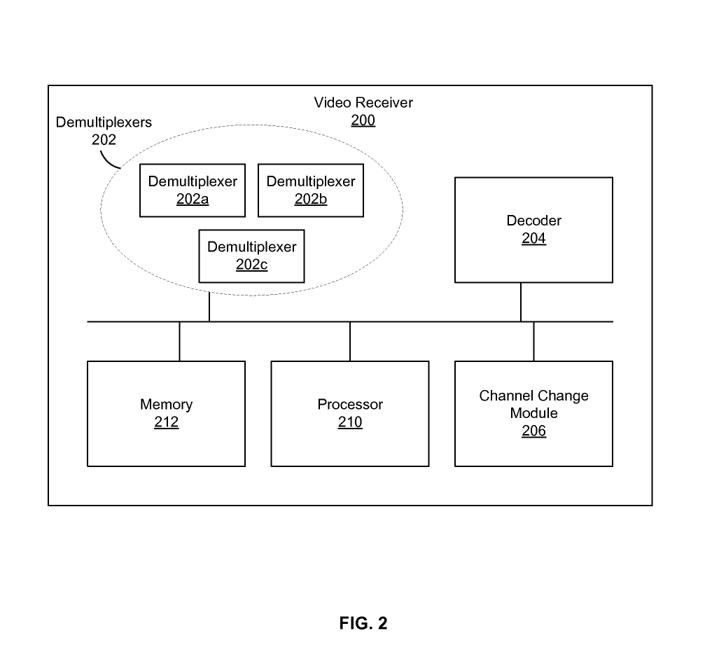

FIG. 2 is a block diagram illustrating an exemplary video receiver that is operable to provide fast channel change between programs utilizing a single decoder to concurrently decode multiple programs, in accordance with an embodiment of the invention. Referring to FIG. 2, there is shown a video receiver 200. The video receiver 200 may comprise a plurality of demultiplexers 202 of which demultiplexers 202a-202c are illustrated, a decoder 204, a channel change module 206, a processor 210 and a memory 212.

Each of the demultiplexers 202 such as the demultiplexer 202a may comprise suitable logic, circuitry, interfaces and/or code that may be operable to receive a transport stream such as the transport stream 120a from a service distributor such as the service distributor 110. The demultiplexer 202a may be operable to extract individual programs in the received transport stream 120a and demultiplex the programs for processing or decoding by the decoder 204.

The decoder 204 may comprise suitable logic, circuitry, interfaces and/or code that may be operable to process or decode compressed program data which may be received from one or more of the transport streams 120. In an exemplary embodiment of the invention, the decoder 204 may be operable to decode concurrently a plurality of programs. The plurality of programs may comprise a current program associated with a current channel and one or more other programs associated with one or more corresponding other channels. In an embodiment of the invention, the plurality of programs may be received by the decoder 204 from a single demultiplexer such as the demultiplexer 202a. In another embodiment of the invention, the plurality of programs may be received by the decoder 204 from a plurality of demultiplexers such as the demultiplexers 202a-202c.

The channel change module 206 may comprise suitable logic, circuitry, interfaces and/or code that may be operable to perform various channel change functions of the video receiver 200. The channel change module 206 may be operable to cause a display device such as the display device 140 to display the decoded current program associated with the current channel for viewing. In an exemplary embodiment of the invention, the channel change module 206 may be operable to switch from the current channel to one of the other channels whose programs are concurrently decoded by the decoder 204. The decoded program associated with the switched channel may be caused by the channel change module 206 to display by the display device 140.

In an exemplary embodiment of the invention, the channel change module 206 may be operable to determine the one or more corresponding other channels which may be concurrently decoded by the decoder 204. In this regard, for example the one or more corresponding other channels may comprise one or more up channels with respect to the current channel and/or one or more down channels with respect to the current channel. In instances when channels are being changed upwards with respect to the current channel, the one or more corresponding other channels may comprise one or more up channels with respect to the current channel. In instances when channels are being changed downwards with respect to the current channel, the one or more corresponding other channels may comprise one or more down channels with respect to the current channel. In an exemplary embodiment of the invention, one of the other channels may comprise a last channel which was previously selected for display.

The processor 210 may comprise suitable logic, circuitry, interfaces and/or code that may be operable to communicate with the decoder 204 and the channel change module 206 to perform the processing or decoding functions and the channel change functions of the video receiver 200.

The memory 212 may comprise suitable logic, circuitry, interfaces and/or code that may be operable to store information such as executable instructions and data that may be utilized by the processor 210, the decoder 204 and/or the channel change module 206 to perform various functions of the video receiver 200.

In operation, the decoder 204 may be operable to decode concurrently a plurality of programs. The plurality of programs may comprise a current program associated with a current channel and one or more other programs associated with one or more corresponding other channels. In an embodiment of the invention, the plurality of programs may be received by the decoder 204 from a single demultiplexer such as the demultiplexer 202a. In another embodiment of the invention, the plurality of programs may be received by the decoder 204 from a plurality of demultiplexers such as the demultiplexers 202a-202c. The channel change module 206 may be operable to communicate with the display device 140 so as to display the decoded current program associated with the current channel for viewing. In an exemplary embodiment of the invention, the channel change module 206 may be operable, based on a received request from a user or viewer, to switch from the current channel to one of the other channels whose programs are concurrently decoded by the decoder 204. The channel change module 206 may then be operable to communicate with the display device 140 so as to display the decoded program which may be associated with the switched channel for viewing.

In an exemplary embodiment of the invention, the channel change module 206 may be operable to determine the one or more corresponding other channels which may be concurrently decoded by the decoder 204. In this regard, for example the one or more corresponding other channels may comprise one or more up channels with respect to the current channel and/or one or more down channels with respect to the current channel when a user or viewer is not in the middle of changing channels or has paused channel changes. For example, the current channel which is being watched may be channel 7. The user is not in the middle of changing channels or has paused channel changes. In this instance, the channel change module 206 may be operable to determine one or more up channels such as channel 9 and channel 12 and one or more down channels such as channel 5 and channel 3 on an available channel list, for example.

In instances when channels are being changed upwards with respect to the current channel, the one or more corresponding other channels may comprise one or more up channels with respect to the current channel. For example, a user may be changing channels upwards from channel 7. In this instance, the channel change module 206 may be operable to determine channel 7, channel 9, channel 11 and channel 12 on an available channel list for being concurrently decoded by the decoder 204, for example. The available channel list may be generated and/or updated based on user's subscription, for example. The available channel list may also be generated and/or updated based on user's favorite channels, for example.

In instances when channels are being changed downwards with respect to the current channel, the one or more corresponding other channels may comprise one or more down channels with respect to the current channel. For example, a user may be changing channels downwards from channel 7. In this instance, the channel change module 206 may be operable to determine channel 7, channel 6, channel 4 and channel 2 on an available channel list for being concurrently decoded by the decoder 204, for example.

In an exemplary embodiment of the invention, one of the other channels may comprise a last channel which was previously selected and displayed. For example, a user who might have previously watched channel 13 has now changed channel from channel 13 to current channel 7. In this instance, the channel change module 206 may be operable to determine that channel 7, which is the current channel, and channel 13, which is the last channel, should be concurrently decoded by the decoder 204 so as to allow fast channel change to and/or from the last channel.

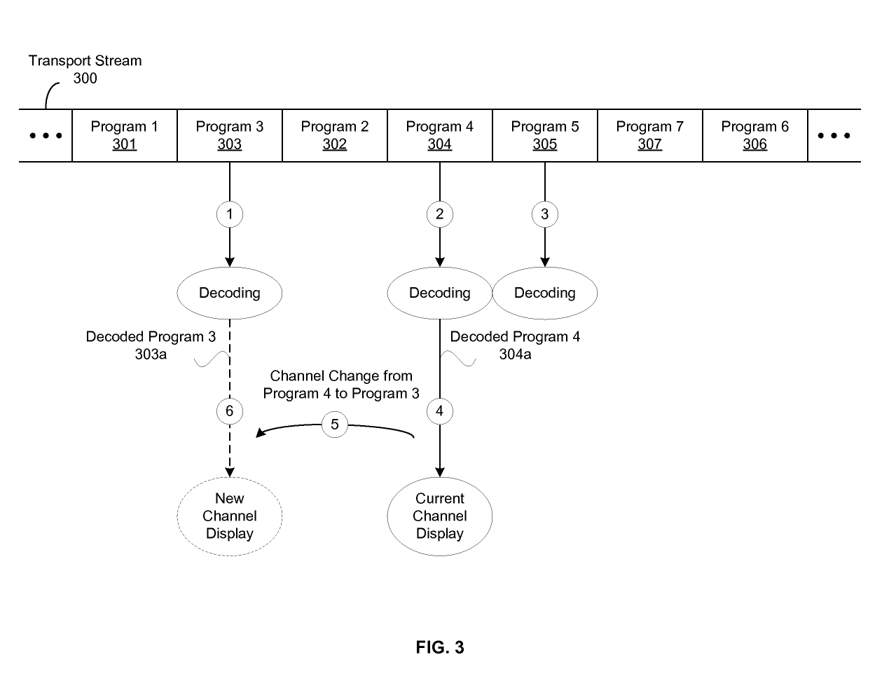

FIG. 3 is a block diagram illustrating an exemplary transport stream comprising a plurality of programs, in accordance with an embodiment of the invention. Referring to FIG. 3, there is shown a transport stream 300. The transport stream 300 may comprise a plurality of multiplexed programs such as program 1 301, program 2 302, program 3 303, program 4 304, program 5 305, program 6 306 and/or program 7 307.

In an exemplary embodiment of the invention, the decoder 204 in the video receiver 200 may be operable to concurrently decode a plurality of programs, such as the program 3 303, the program 4 304 and the program 5 305, as illustrated by the reference labels 1, 2, 3. The channel change module 206 in the video receiver 200 may be operable to cause display of the decoded program 4 304a which is associated with a current channel for viewing, as illustrated by the reference label 4. A channel change from the decoded program 4 304a to the decoded program 3 303a may be performed by the channel change module 206 as illustrated by the reference label 5, for example. The channel change module 206 may then cause display of the decoded program 3 303a which is associated with a newly switched channel for viewing, as illustrated by the reference label 6. In this regard, since the decoded program 303a has already been decoded by the decoder 204 before a channel change, the delays associated with steps in the channel change sequence may be avoided or reduced.

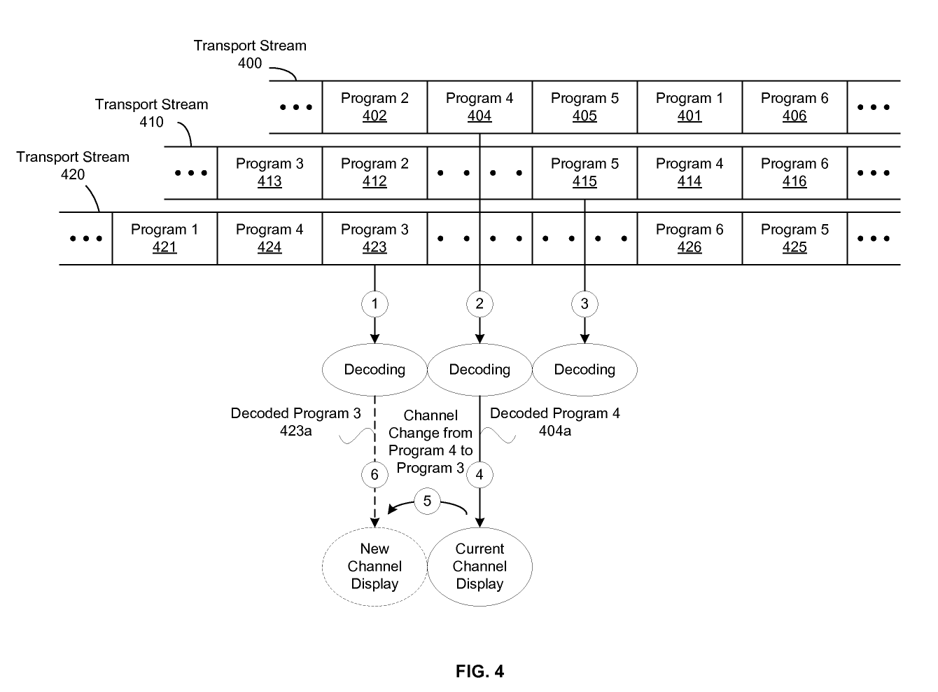

FIG. 4 is a block diagram illustrating exemplary multiple transport streams each comprising a plurality of programs, in accordance with an embodiment of the invention. Referring to FIG. 4, there is shown a plurality of transport streams such as transport streams 400, 410, 420. The transport stream 400 may comprise a plurality of multiplexed programs such as program 1 401, program 2 402, program 4 404, program 5 405 and/or program 6 406. The transport stream 410 may comprise a plurality of multiplexed programs such as program 2 412, program 3 413, program 4 414, program 5 415 and/or program 6 416. The transport stream 420 may comprise a plurality of multiplexed programs such as program 1 421, program 3 423, program 4 424, program 5 425 and/or program 6 426.

In an exemplary embodiment of the invention, the decoder 204 in the video receiver 200 may be operable to concurrently decode a plurality of programs received from multiple transport streams 400, 410, 420. For example, the decoder 204 may concurrently decode the program 3 423 received from the transport stream 420, the program 4 404 received from the transport stream 400 and the program 5 415 received from the transport stream 410, as illustrated by the reference labels 1, 2, 3. The channel change module 206 in the video receiver 200 may be operable to cause display of the decoded program 4 404a which is associated with a current channel for viewing, as illustrated by the reference label 4. A channel change from the decoded program 4 404a to the decoded program 3 423a may be performed by the channel change module 206 as illustrated by the reference label 5, for example. The channel change module 206 may then cause display of the decoded program 3 423a which is associated with a newly switched channel for viewing, as illustrated by the reference label 6. In this regard, since the decoded program 303a has already been decoded by the decoder 204 before a channel change, the delays associated with steps in the channel change sequence may be avoided or reduced.

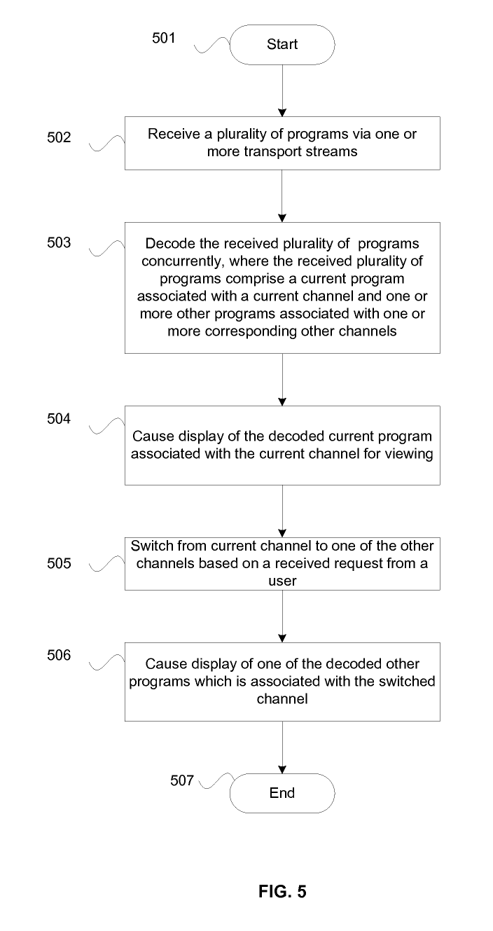

FIG. 5 is a flow chart illustrating exemplary steps for fast channel change between programs utilizing a single decoder to concurrently decode multiple programs, in accordance with an embodiment of the invention. Referring to FIG. 5, the exemplary steps start at step 501. In step 502, the demultiplexers 202 in the video receiver 200 may be operable to receive a plurality of programs via one or more transport streams 120. In step 503, the decoder 204 in the video receiver 200 may be operable to decode the received plurality of programs concurrently. The received plurality of programs may comprise a current program associated with a current channel and one or more other programs associated with one or more corresponding other channels. In step 504, the channel change module 206 in the video receiver 200 may be operable to cause display of the decoded current program associated with the current channel for viewing. In step 505, the channel change module 206 may be operable to switch from the current channel to one of the other channels based on a received request from a user. In step 506, the channel change module 206 may be operable to cause display of one of the decoded other programs which may be associated with the switched channel. The exemplary steps may proceed to the end step 507.

In various embodiments of the invention, a video receiver 200 comprising a single decoder such as the decoder 204 may be operable to concurrently decode, by the decoder 204, a plurality of received programs, where the plurality of received programs may comprise a current program associated with a current channel and one or more other programs associated with one or more corresponding other channels. A channel change module 206 in the video receiver 200 may be operable to cause display of the decoded current program associated with the current channel for viewing. In an embodiment of the invention, the plurality of received programs may be received by a demultiplexer 202a in the video receiver 200 via a single transport stream 120a. In another embodiment of the invention, the plurality of received programs may be received by a plurality of demultiplexers 202a-202c in the video receiver 200 via a plurality of transport streams 120a-120c.

The channel change module may be operable to receive a request from a user to switch channel from the current channel to one of the other channels. In this regard, the channel change module 206 may be operable to switch from the current channel to one of the other channels based on the received request from the user. The channel change module 206 may be operable to cause display of one of the decoded other programs which may be associated with the switched channel.

In an exemplary embodiment of the invention, the one or more corresponding other channels may comprise one or more up channels with respect to the current channel and/or one or more down channels with respect to the current channel. In instances when channels are being changed upwards with respect to the current channel, the one or more corresponding other channels may comprise one or more up channels with respect to the current channel. In instances when channels are being changed downwards with respect to the current channel, the one or more corresponding other channels may comprise one or more down channels with respect to the current channel. One of the other channels may comprise a last channel which was previously selected for display, for example.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for fast channel change between programs utilizing a single decoder to concurrently decode multiple programs.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in a video receiver comprising a single decoder:
concurrently decoding, by said single decoder, a plurality of received programs, wherein said plurality of received programs comprise a current program associated with a current channel and one or more other programs associated with one or more corresponding other channels; and
causing display of said decoded current program associated with said current channel for viewing.

2. The method according to claim 1, comprising receiving said plurality of received programs via a single transport stream.

3. The method according to claim 1, comprising receiving said plurality of received programs via a plurality of transport streams.

4. The method according to claim 1, comprising receiving a request to switch channel from said current channel to one of said other channels.

5. The method according to claim 4, comprising switching from said current channel to said one of said other channels based on said received request.

6. The method according to claim 5, comprising causing display of one of said decoded other programs which is associated with said one of said other channels.

7. The method according to claim 1, wherein said one or more corresponding other channels comprise one or more up channels with respect to said current channel and/or one or more down channels with respect to said current channel.

8. The method according to claim 1, wherein when channels are being changed upwards with respect to said current channel, said one or more corresponding other channels comprise one or more up channels with respect to said current channel.

9. The method according to claim 1, wherein when channels are being changed downwards with respect to said current channel, said one or more corresponding other channels comprise one or more down channels with respect to said current channel.

10. The method according to claim 1, wherein one of said other channels comprises a last channel which was previously selected for display.

11. A system for communication, the system comprising:
one or more processors and/or circuits for use in a video receiver comprising a single decoder, said one or more processors and/or circuits being operable to:
concurrently decode, by said single decoder, a plurality of received programs, wherein said plurality of received programs comprise a current program associated with a current channel and one or more other programs associated with one or more corresponding other channels; and
cause display of said decoded current program associated with said current channel for viewing.

12. The system according to claim 11, wherein said one or more processors and/or circuits are operable to receive said plurality of received programs via a single transport stream.

13. The system according to claim 11, wherein said one or more processors and/or circuits are operable to receive said plurality of received programs via a plurality of transport streams.

14. The system according to claim 11, wherein said one or more processors and/or circuits are operable to receive a request to switch channel from said current channel to one of said other channels.

15. The system according to claim 14, wherein said one or more processors and/or circuits are operable to switch from said current channel to said one of said other channels based on said received request.

16. The system according to claim 15, wherein said one or more processors and/or circuits are operable to cause display of one of said decoded other programs which is associated with said one of said other channels.

17. The system according to claim 11, wherein said one or more corresponding other channels comprise one or more up channels with respect to said current channel and/or one or more down channels with respect to said current channel.

18. The system according to claim 11, wherein when channels are being changed upwards with respect to said current channel, said one or more corresponding other channels comprise one or more up channels with respect to said current channel.

19. The system according to claim 11, wherein when channels are being changed downwards with respect to said current channel, said one or more corresponding other channels comprise one or more down channels with respect to said current channel.

20. The system according to claim 11, wherein one of said other channels comprises a last channel which was previously selected for display.
